(19) United States
(12) Patent Application Publication
(10) Pub. No.: US 2004/0213888 A1
(43) Pub. Date: Oct. 28, 2004

(54) Soybean milk paste with high concentrations and process for producing the same

(76) Inventors: Yoshimichi Hoshi, Yokohama-shi (JP); Yoshio Takada, Yamatokouriyama-shi (JP); Hideto Chitose, Osaka-shi (JP)

Correspondence Address: Koda & Androlia, Suite 1430, 2029 Century Park East, Los Angeles, CA, 90067, US

(21) Appl. No.: 10/487,787

(22) PCT Filed: Aug. 30, 2002
(86) PCT No.: PCT/JP02/08834

(30) Foreign Application Priority Data
Aug. 31, 2001 (JP) 2001-264301
Aug. 20, 2002 (JP) 2002-239612

(51) Int. Cl. A23L 1/20

(52) U.S. Cl. 426/634

(57) ABSTRACT

Highly concentrated soybean milk paste is produced by mixing and stirring soybean powder (11) into cold or warm water (W) to make a “fresh go” (milled soybean paste) (2) with a concentration of 21±4 BRIX, putting the “fresh go” in a wrapped state, boiling and heating the “fresh go”, and cooling the “fresh go”. A process for producing highly concentrated soybean milk paste includes the making step of making a “fresh go” with a concentration of 21±4 BRIX by mixing and stirring soybean powder into cold or warm water, the heating step of boiling the “fresh go” in a wrapped state to produce soybean milk paste, and the cooling step of cooling the soybean milk paste as is in the wrapped state. Thus, the present invention provides highly concentrated soybean milk paste, which contains the whole components of soybeans, which is contaminated with little bacteria and which is produced at low cost. The present invention also provides a process for producing highly concentrated soybean milk paste, which is timesaving, which does not require any expensive special machines, and which prevents the growth of bacteria.

### TECHNICAL FIELD

This invention relates to a highly concentrated soybean milk paste and a process for producing the same.

### BACKGROUND ART

Recent re-recognition of nutritional value of soybean milk has impelled to use soybean milk into a variety of food products, such as puddings, ice creams, doughnuts and so on.

Generally, soybean milk for tofu (bean curd) is produced by milling soybeans by a grinder or the like to make a “go” (a milled soybean paste) after washing the soybeans and soaking them in a soaking tank, then heating the “go” for 2 to 5 minutes at of 98 to 105° C. (hereinafter the non-heated “go” is called as a “fresh go”) and removing tofu refuse (what remains after the “fresh go” and the heated “go” being filtered).

The concentration of the above-mentioned soybean milk is approximately 10 to 13 BRIX. Therefore, there has been a demand in the above-mentioned food products industry for development of soybean milk that is highly concentrated and contains the whole components of the soybeans (all nutritional value of the soybeans).

However, concentrating regular soybean milk with a concentration of 10 to 13 BRIX to approximately 21 BRIX requires an expensive special machine and consumes time, growth of bacteria is accelerated in the concentration process, and therefore highly concentrated soybean milk has never been commercialized. The special machine is designed to use for soybean milk in which tofu refuse has been removed and inevitably spoils parts of nutritional value of the soybeans.

Accordingly, an object of the present invention is to provide a highly concentrated soybean milk paste, \mathring{1} which contains the whole components of soybeans, \mathring{2} which is contaminated with little bacteria, and \mathring{3} which is produced at low cost.

Another object of the present invention is to provide a process for producing a highly concentrated soybean milk paste, \mathring{1} which is timesaving, \mathring{2} which does not require any expensive special machines, and \mathring{3} which prevents the growth of bacteria.

### DISCLOSURE OF INVENTION

A highly concentrated soybean milk paste of the present invention is produced by mixing and stirring soybean powder into cold or warm water to make a “fresh go” with a concentration of 21±4 BRIX, putting the “fresh go” in a wrapped state, boiling and heating the “fresh go”, and then cooling the “fresh go”.

A highly concentrated soybean milk paste of the present invention is produced by miming and stirring soybean powder into cold or warm water to make a “fresh go” with a concentration of 21±4 BRIX, putting the “fresh go” into a retort pouch, and processing the “fresh go” in the retort pouch by boiling, heating, and subsequent cooling, or pressure-heating for pasteurization.

A highly concentrated soybean milk paste of the present invention is produced by mining and stirring soybean powder into cold or warm water to make a “go” with a concentration of 21±4 BRIX, putting the “fresh go” into a heat-resistant bag, boiling and heating the “fresh go”, and then cooling the “fresh go”.

In the highly concentrated soybean milk paste of the present invention, food products or processed food products may be mixed in the soybean powder. Alternatively, the food products or processed food products may be mixed in the “fresh go” with a concentration of 21±4 BRIX, which is made by mixing and stirring soybean powder into cold or warm water.

A process for producing a highly concentrated soybean milk paste of the present invention includes a making step of making a “fresh go” with a concentration of 21±4 BRIX by mixing and stirring soybean powder into cold or warm water, a heating step of boiling the “fresh go” in a wrapped state to produce a soybean milk paste, and a cooling step of cooling the soybean milk paste in the wrapped state. In the heating step, the “fresh go” may be boiled in a heat-resistant bag and the “fresh go” may be cooled as is in the bag in the cooling step.

A process for producing a highly concentrated soybean milk paste of the present invention includes a making step of making a “fresh go” with a concentration of 21±4 BRIX by mixing and stirring soybean powder into cold or warm water, a heating step of boiling the “fresh go” in a retort pouch to produce a soybean milk paste, and a cooling step of cooling the soybean milk paste as is in the retort pouch.

A process for producing a highly concentrated soybean milk paste of the present invention includes the making step of making a “fresh go” with a concentration of 21±4 BRIX by mixing and stirring a soybean powder into cold or warm water and a heating step of pressure-heating the “fresh go” in a retort pouch for pasteurization to produce a soybean milk paste.

In the process for producing a highly concentrated soybean milk paste of the present invention, food products or processed food products may be mixed in the soybean powder. Alternatively, the food products or the processed food products may be mixed in the “fresh go” with a concentration of 21±4 BRIX, which is made by mixing and stirring soybean powder into cold or warm water.

A highly concentrated soybean milk paste of the present invention is produced by mixing and stirring milled soybeans (soybeans which are milled by a millstone or other machines) or soybean flakes into cold or warm water to make a “fresh go” with a concentration of 21±4 BRIX putting the “fresh go” in a wrapped state, boiling and heating the “fresh go”, and then cooling the “fresh go”.

A highly concentrated soybean milk paste of the present invention is produced by mixing and stirring milled soybeans or soybean flakes into cold or warm water to make a “fresh go” with a concentration of 21±4 BRIX, putting the “fresh go” into a retort pouch, and processing the “fresh go” in the retort pouch by boiling, heating, and subsequent cooling, or pressure-heating for pasteurization.

A highly concentrated soybean milk paste of the present invention is produced by mixing and stirring milled soybeans or soybean flakes into cold or warm water to make a “fresh go” with a concentration of 21±4 BRIX, putting the “fresh go” into a heat-resistant bag, boiling the “fresh go”, and then cooling the “fresh go”.

In the highly concentrated soybean milk paste of the present invention, food products or processed food products maybe mixed in the milled sons or soybean flakes. Alternatively, the food products or the processed food products may be mixed in the “fresh go” with a concentration of 21±4 BRIX, which is made by mixing and stirring milled soybeans or soybean flakes into cold or warm water.

A process for producing a highly concentrated soybean milk paste of the present invention includes a making step of making a “fresh go” with a concentration of 21±4 BRIX by mixing and stirring milled soybeans or soybean flakes into cold or warm water, a heating step of boiling the “fresh go” in a wrapped state to produce a soybean milk paste, and a cooling step of cooling the soybean milk paste as is in the wrapped state. In the heating step, the “fresh go” may be boiled in a heat-resistant bag and the “fresh go” may be cooled as is in the bag in the cooling step.

A process for producing a highly concentrated soybean milk paste of the present invention includes a making step of making a “fresh go” with a concentration of 21±4 BRIX by mixing and stirring milled soybeans or soybean flakes into cold or warm water, a heating step of boiling the “fresh go” in a retort pouch to produce a soybean milk paste, and a cooling step of cooling the soybean milk paste as is in the retort pouch.

A process for producing a highly concentrated soybean milk paste of the present invention includes a making step of making a “fresh go” with a concentration of 21±4 BRIX by mixing and stirring milled soybeans or soybean flakes into cold or warm water and a heating step of pressure-heating the “fresh go” in a retort pouch for pasteurization to produce a soybean milk paste.

In the process for producing a highly concentrated soybean milk paste of the present invention, food products or processed food products may be mixed in the milled soybeans or the soybean flakes. Alternatively, the food products or the processed food products may be mixed in the “fresh go” with a concentration of 21±4 BRIX, which is made by mixing and stirring milled soybeans or soybean flakes into cold or warm water.

A highly concentrated soybean milk paste with a concentration of 22±4 BRIX of the present invention is produced by making a “fresh go” by mixing and stirring soybean powder, milled soybeans, or soybean flakes into cold or warm water, putting the “fresh go” in a wrapped state, and boiling and heating the “fresh go”, followed by cooling.

A highly concentrated soybean milk paste with a concentration of 22±4 BRIX of the present invention is produced by making a “fresh go” by mixing and stirring soybean powder, milled soybeans, or soybean flakes into cold or warm water, putting the “fresh go” into a retort pouch, and boiling and heating the “fresh go”, followed by cooling.

A highly concentrated soybean milk paste with a concentration of 22±4 BRIX of the present invention is produced by making a “fresh go” by mixing and stirring soybean powder, milled soybeans, or soybean flakes into cold or warm water, putting the “fresh go” into a retort pouch, and pressure-heating the “fresh go” for pasteurization followed by cooling.

A highly concentrated soybean milk paste with a concentration of 22±4 BRIX of the present invention is produced by making a “fresh go” by mixing and stirring soybean powder, milled soybeans, or soybean flakes into cold or warm water, putting the “fresh go” into a heat-resistant bag, and boiling and heating the “fresh go”, followed by cooling.

The above and other objects, features and advantages of the present invention will become apparent from the following description read in conjunction with the accompanying drawings.

### BRIEF DESCRIPTION OF DRAWINGS

FIG. 1 is a flow chart showing a process for producing a highly concentrated soybean milk paste (P) according to an embodiment of the present invention.

### BEST MODE FOR CARRYING OUT THE INVENTION

(Embodiment 1)

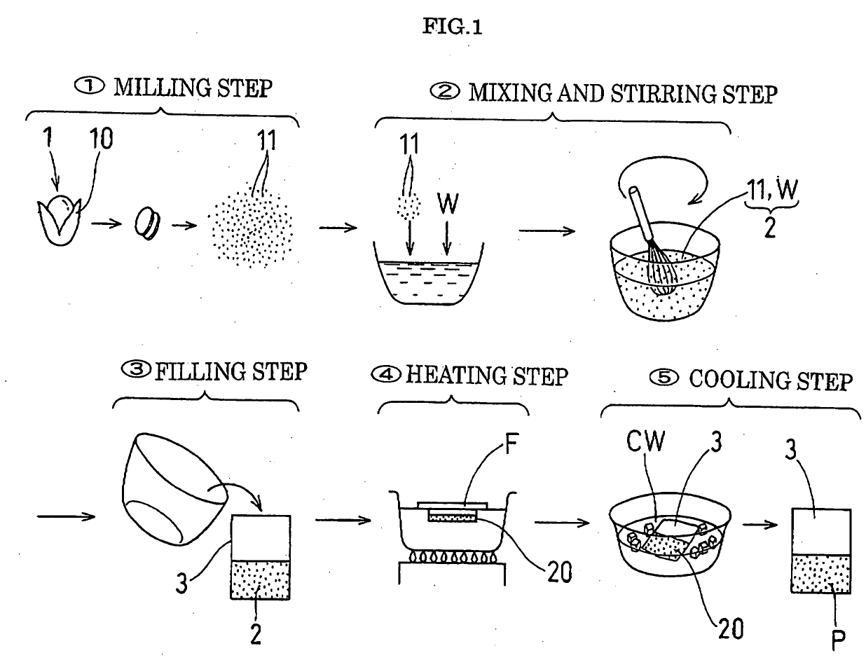

FIG. 1 shows a process for producing a highly concentrated soybean milk paste (P) according to an embodiment of the present invention.

The highly concentrated soybean milk paste (P) according to this embodiment is set to have a concentration of 21 to 22 BRIX in a sealed state in a heat-resistant polyethylene bag.

As shown in FIG. 1, the highly concentrated soybean milk paste (P) is produced by going through each of the following steps.

\mathring{1}. A Milling Step

After peeling off husks 10 of soybeans 1 and slicing them without damaging any components of soybeans 1, soybeans 1 are milled in an average grain size of 27 μm (micron) [it can be any sizes within a range of 0.1 to 210 μm] so as to make soybean powder 11 that is used as a basic ingredient of a soybean milk paste (P).

Soybeans 1 may be directly milled after peeling off the husks.

\mathring{2}. A Mixing and Stirring Step

The soybean powder 11 as a basic ingredient is mixed into warm water (W) (or cold water) in a vessel in the proportion of 1 g (gram) of the soybean powder 11 to 2.8 g of warm water (W) (or cold water) and then the mixture is stirred by a mechanical stirrer. The soybean powder 11 is easily dissolved in warm water (W) (or cold water) and therefore water-soluble protein can be easily extracted from the mixture.

A “fresh go” 2 with a concentration of 20 to 21 BRIX is obtained by the above step.

In case of operating this process for business purposes, a homomixer may be used for the continuous operation such as mixing and stirring.

\mathring{3}. A Filling Step

A heat-resistant polyethylene bag 3 is filled with the “fresh go”. In this filling step of putting the “fresh go” 2 into the bag 3, approximately 40 to 70 percent of capacity of the bag 3 is filled with the “fresh go” 2. The bag 3 is sealed after air is thoroughly removed from the bag 3. It is preferable that an easily sealable and unsealable type of bag is used for the bag 3. In addition, the bag 3 does not have to be made of polyethylene as long as it is made of heat-resistant resinous materials.

In case of operating this process for business purposes, the “fresh go” 2 in the above-mentioned homomixer is sent to a bag-filling machine by a pump for the filling step.

\mathring{4}. A Heating Step

After boiling water in a pot or a kettle, the sealed bag 3 filled with the “fresh go” 2 is put into the boiling water. During this heating step, a lid (F) is placed on the bag 3 to prevent the upper side of the bag 3 from coming out from the surface of the boiling water. The bag 3 is heated for 10 to 20 minutes with being turned over 1 to 2 times so that the entire “fresh go” 2 in the bag 3 is substantially uniformly heated.

In this heating step, the tense of the “fresh go” 2 goes up to approximately 93 to 94° C. because of the temperature (98° C.) of the boiling water and therefore the characteristic smell of soybeans is eliminated as well as the “fresh go” 2 is pasteurized. Because no bubble is produced in this heating step, anti-bubbling agent is not required.

Other heating methods were also used to heat the “fresh go” 2. When a method of heating the “fresh go” 2 in a kettle pot or the like over an open fire was used, the soybean protein ended up getting burned. When another method of quickly heating the “fresh go” 2 by a microwave oven or the like is used, the “fresh go” 2 was failed to be heated uniformly because of bubble formation.

\mathring{5}. A Cooling Step

The bag 3 filled with a soybean milk paste 20 is put in cool water (CW) such as ice water or the like for cooling after the heating step so that the process of producing the high concentration of soybean milk paste (P) is completed. In addition, quick cooling methods are preferred for cooling in order to prevent the growth of bacteria.

In case of operating this process for business purpose, a cooling tank the temperature of which is approximately 2 to 10° C. is used.

The above-mentioned highly concentrated soybean milk paste (P) and the process for producing the same have the following advantages. The nutritional value of the soybean milk paste (P) is relatively high compared to the conventional soybean milk because the “fresh go” 2 from which the highly concentrated soybean milk paste (P) is obtained is made of soybean powder 11, which is made by milling soybeans 1 after peeling off husks 10, and water.

Moreover, the bag 3 filled with only the “fresh go” 2 is sealed in the filling step after air is thoroughly removed from the bag 3, followed by boiling so that the highly concentrated soybean milk paste (P) is contaminated with little bacteria.

Furthermore, the highly concentrated soybean milk paste (P) is produced at low cost because no expensive special machines for the concentration are required in the above-mentioned process and it takes only about 2 to 4 hours to follow all steps of the above-mentioned process although it takes more than 20 hours when conventional methods are used.

(Embodiment 2)

The “fresh go” 2 may be put into a retort pouch instead of into the heat-resistant polyethylene bag 3 which is used in the embodiment 1.

In this case, the “fresh go” 2 may be boiled in a retort pouch to produce a soybean milk paste, followed by cooling the soybean milk paste as is in the retort pouch. The “fresh go” 2 in a retort pouch may be pressure-heated for pasteurization to produce a soybean milk paste. When the “fresh go” 2 is pressure-heated for pasteurization, there is no need to cool the “fresh go” 2 although it may be cooled.

(Other Embodiments)

\mathring{1}. A “fresh go” may be heated while being intermittently or slowly transferred in a tube in a boiling water so as to produce a soybean milk paste. In this case, the “mesh go” is in a wrapped state in the tube.

\mathring{2}. The “fresh go” maybe put and sealed into each of many bag segments (or bags) that connect to form a long belt body and heated while the belt body being entirely immersed in boiling water to produce a soybean milk paste. Alternatively, as the belt body is longitudinally, intermittently or slowly forwarded, a batch of bag segments is in turn immersed in boiling water for a certain time and a soybean milk paste is produced. In this case, after being cooled, respective bag segments may be cut away from the body.

\mathring{3}. The “fresh go” in respective bags can be uniformly boiled by using a shelf hat includes bag-housing spaces vertically and horizontally at the time of immersing bags in boiling water because the shelf prevents the bags from overlapping each other. This makes it possible to produce a lot of soybean milk paste at a time which has been uniformly boiled.

\mathring{4}. The concentration BRIX of “fresh go” 2 can be changed by changing the weight ratio of soybean powder 11, used as a basic ingredient, to warm water (W) (or water) mixed with the soybean powder 11 as follows so that the concentration BRIX of the soybean milk paste can be changed.

3 g of warm water (W) for 1 g of the soybean powder 11

→The “fresh go” with the concentration of 17 to 18 BRIX→The soybean milk paste with the concentration of 18 to 19 BRIX

2.5 g of warm water (W) for 1 g of the soybean powder 11

→The “fresh go” with the concentration of 22 BRIX→The soybean milk paste with the concentration of 23 BRIX

The weight ratio of the soybean powder 11, used as a basic ingredient, to warm water (W) (or water) mixed with the soybean powder 11 maybe 1:(2 to 3). However, the weight ratio of 1:(2 to 4) can be applied, which is depending on the kinds of soybeans or the component of soybeans, and even in this weight ratio, “fresh go” with a concentration of 21±4 BRIX can be produced

\mathring{5}. Although the soybean powder 11 is used as a basic ingredient in the above embodiments, it is not limited to it. Milled soybeans (which are soybeans milled by a millstone or the like. If milled soybeans are used, the mixing and sting time of the above-mentioned step \mathring{2} will be extended.) or soybean flakes may be used as a basic ingredient.

The soybean powder 11, the milled soybeans, or the soybean flakes (soybean slices, pressed soybeans) may be made by processing soybeans with or without husks.

Even in these cases, a soybean milk paste (P) with substantially the same high concentration as stated above can be produced by the same process.

\mathring{6}. The soybean powder is gradually heated in order not to get burned, followed by adding warm water or water to the heated soybean powder and then stirring the mixture so that a soybean milk paste (P) with the same high concentration as stated above can be produced.

\mathring{7}. The soybean milk paste may be mixed with one or more of the following food products or processed food products, A to Q. In case of producing the highly concentrated soybean milk paste mixed with these food products or processed food products, they may be mixed in the soybean powder 11, milled soybeans, or soybean flakes in the above-mentioned mixing and stirring step \mathring{2}, or mixed in the “fish go” with the concentration of 21±4 BRIX which is made by mixing and stirring the soybean powder 11, milled soybeans, or soybean flakes into water or warm water.

However, if liquid types of these processed food products, A to Q, are mixed in the highly concentrated soybean milk paste, the amount of the liquid has to be small (as much as the “fresh go” is able to keep its paste form).

A. Grains: rice, barley, wheat or other grains and processed grains products

B. Potatoes and starches: sweet potato, white potato, other potatoes and starches or processed potatoes and starches products

C. Sugars and sweets: sugar, starch syrup, powdered candy, honey, glucose, other sugars and sweets or processed sugars and sweets products

D. Pulse: soybean, miso, processed soybean products, other pulse or processed pulse products

E. Nuts and seeds: walnut, sesame, chestnut, peanut, other nuts and seeds or processed nuts and seeds products

F. Vegetables: carrot, pumpkin, green vegetables, Japanese radish, burdock, Chinese cabbage, cucumber, cabbage, onion, tomato, eggplant, string beans, other vegetables or processed vegetables products

G. Fruits: orange, lemon, citrus fruits such as Chinese citron, apple, pear, banana, grape, peach, ume, other fruits or processed fruits products

H. Mushrooms: shiitake mushroom, matsutake mushroom, shimeji mushroom, enokidake mushroom, nameko mushroom, mushroom, other mushrooms or processed mushroom products

I. Algae: kombu, wakame, seaweed, hijiki, mozuku, green layer, agar, other algae or processed algae products

J. Seafood: fish, shellfish, squid, shrimp, crab, other seafood or processed seafood products

K. Meat: beef, pork, chicken, other meat or processed meat products

L. Eggs: Ukokkei fowl's egg, quail's egg, hen's egg, pi-tan, other eggs or processed eggs products

M. Milk: cow's milk, goat's milk, cream, cheese, other milk or processed milk products

N. Oils and fats: vegetable oil, butter, margarine, animal fats, other oils and fats or processed oils and fats products

O. Confectionery crackers, rice crackers, bun with a bean-jam filling, sponge cake, cake, chocolate, cookie, other confectioneries or processed confectioneries products

P. Beverages: coffee, green tea, tea, cold beverage, alcohol beverage, other beverages or processed beverages products

Q. Seasonings and condiments: soy sauce, sauce, vinegar, salt, mayonnaise, ketchup, curry roux, sesame, curry powder, mustard powder, wasabi powder, other seasonings and condiments or processed seasoning and condiments products

R. Prepared foods: frozen shrimp gratin, frozen croquette, beef stew, other prepared foods or processed foods products

S. Mineral, vitamin, nutrients, micronutrients, enzyme, bittern, all food additives, edible microorganisms (molds, natural yeast, bacteria), lactic acid bacteria

\mathring{8}. The highly concentrated soybean milk paste may be produced by not only the foregoing processes but also other processes as long as they may produce a soybean milk paste with a concentration of 22±4 BRIX by making a “fresh go” by mixing and stirring soybean powder, milled soybeans, or soybean flakes into water or warm water, putting the “fresh go” in a wrapped state (putting in a heat-resistant bag), boiling and heating the “fresh go”, and then cooling the same.

The highly concentrated soybean milk paste with the concentration of 22±4 BRIX may be also produced by making a “fresh go” by mixing and stirring soybean powder, milled soybeans, or soybean flakes into water or warm water, putting the “fresh go” into a retort pouch, and processing the “fresh go” in the retort pouch by boiling, heating and subsequent cooling, or pressure-heating for pasteurization.

As is clear from the above description of the highly concentrated soybean milk paste, the present invention provides a highly concentrated soybean milk paste, \mathring{1} which contains the whole components of soybeans, \mathring{2} which is contaminated with little bacteria, and \mathring{3} which is produced at low cost.

As is clear from the above description of the process of the highly concentrated soybean milk paste, the present invention provides a process for producing a highly concentrated soybean milk paste, \mathring{1} which is timesaving, \mathring{2} which does not require any expensive special machines, and \mathring{3} which prevents the growth of bacteria.

1. A highly concentrated soybean milk paste produced by a process comprising:
providing a “fresh go” with a concentration of 21±4 BRIX by mixing and stirring soybean powder into cold or warm water;
putting the “fresh go” in a wrapped state;
boiling and heating the “fresh go”; and
cooling the “fresh go”.

2. A highly concentrated soybean milk paste produced by a process comprising:
providing a “fresh go” with a concentration of 21±4 BRIX by mixing and stirring soybean powder into cold or warm water;
putting the “fresh go” into a retort pouch; and
processing the “fresh go” in the retort pouch by boiling, heating, and subsequent cooling, or pressure-heating for pasteurization.

3. A highly concentrated soybean milk paste produced by a process comprising:
providing a “fresh go” with a concentration of 21±4 BRIX by mixing and stirring soybean powder into cold or warn water;
putting the “fresh go” into a heat-resistant bag;
boiling and heating the “fresh go”; and
cooling the “fresh go”.

4. A method for producing a highly concentrated soybean milk paste comprising the steps of:
providing a “fresh go” with a concentration of 21±4 BRIX by mixing and stirring soybean powder into cold or warm water;
boiling and heating the “fresh go” in a wrapped state to produce a soybean milk paste; and
cooling the soybean milk paste in the wrapped state.

5. A method for producing a highly concentrated soybean milk paste comprising the steps of:
providing a “fresh go” with a concentration of 21±4 BRIX by mixing and stirring soybean powder into cold or warm water;
boiling and heating the “fresh go” in a retort pouch to produce a soybean milk paste; and
cooling the soybean milk paste in the retort pouch.

6. A method for producing a highly concentrated soybean milk paste comprising the steps of:
providing a “fresh go” with a concentration of 21±4 BRIX by mixing and stirring soybean powder into cold or warm water; and
pressure-heating the “fresh go” in a retort pouch for pasteurization to produce a soybean milk paste.

7. The method for producing a highly concentrated soybean milk paste according to claim 4, wherein the “fresh go” is boiled and heated in a heat-resistant bag in the heating step and cooled in the bag in the cooling step.

8. A highly concentrated soybean milk paste produced by a process comprising:
providing a “fresh go” with a concentration of 21±4 BRIX by mixing and stirring any one of milled soybeans and soybean flakes into cold or warm water;
putting the “fresh go” in a wrapped state;
boiling and heating the “fresh go”; and
cooling the “fresh go”.

9. A highly concentrated soybean milk paste produced by a process comprising:
providing a “fresh go” with a concentration of 21±4 BRIX by mixing and stirring any one of milled soybeans and soybean flakes into cold or warm water;
putting the “fresh go” into a retort pouch; and
processing the “fresh go” in the retort pouch by boiling, heating, and subsequent cooling, or pressure-heating for pasteurization.

10. A highly concentrated soybean milk paste produced by a process comprising:
providing a “fresh go” with a concentration of 21±4 BRIX by mixing and stirring any one of milled soybeans and soybean flakes into cold or warm water;
putting the “fresh go” into a heat-resistant bag;
boiling and heating the “fresh go”; and
cooling the “fresh go”.

11. A method for producing a highly concentrated soybean milk paste comprising the steps of:
providing a “fresh go” with a concentration of 21±4 BRIX by mixing and stirring any one of milled soybeans and soybean flakes into cold or warm water;
boiling and heating the “fresh go” in a wrapped state to produce a soybean milk paste; and
cooling the soybean milk paste in the wrapped state.

12. A method for producing a highly concentrated soybean milk paste comprising the steps of:
providing a “fresh go” with a concentration of 21±4 BRIX by mixing and stirring any one of milled soybeans and soybean flakes into cold or warm water;
boiling and heating the “fresh go” in a retort pouch to produce a soybean milk paste; and
cooling the soybean milk paste in the retort pouch.

13. A method for producing a highly concentrated soybean milk paste comprising the steps of:
providing a “fresh go” with a concentration of 21±4 BRIX by mixing and stifling any one of milled soybeans and soybean flakes into cold or warm water; and
pressure-heating the “fresh go” in a retort pouch for pasteurization to produce a soybean milk paste.

14. The method for producing a highly concentrated soybean milk paste according to claim 11, wherein the “fresh go” is boiled and heated in a heat-resistant bag in the heating step and cooled in the bag in the cooling step.

15. The highly concentrated soybean milk paste according to any one of claim 1, 2, and 3, wherein any one of food products and processed food products are mixed in the soybean powder.

16. The highly concentrated soybean milk paste according to any one of claim 1, 2, and 3, wherein any one of food products and processed food products are mixed in the “fresh go”.

17. The method for producing a highly concentrated soybean milk paste according to any one of claim 4, 5, 6, and 7, wherein any one of food products and processed food products are mixed in the soybean powder.

18. The method for producing a highly concentrated soybean milk paste according to any one of claim 4, 5, 6, and 7, wherein any one of food products and processed food products are mixed in the “fresh go”.

19. The highly concentrated soybean milk paste according to any one of claim 8, 9, and 10, wherein any one of food products and processed food products are mixed in any one of the milled soybeans and the soybean flakes.

20. The highly concentrated soybean milk paste according to any one of claim 8, 9, and 10, wherein any one of food products and processed food products are mixed in the “fresh go”.

21. The method for producing a highly concentrated soybean milk paste according to any one of claim 11, 12, 13, and 14, wherein anyone of food products and processed food products are nixed in anyone of the milled soybeans and the soybean flakes.

22. The method for producing a highly concentrated soybean milk paste according to any one of claim 11, 12, 13, and 14, wherein anyone of food products and processed food products are nixed in the “fresh go”.

23. A highly concentrated soybean milk paste with a concentration of 22±4 BRIX produced by a process comprising:
providing a “fresh go” by mixing and stirring any one of soybean powder, milled soybeans, and soybean flakes into cold or warm water;
putting the “fresh go” in a wrapped state;
boiling and heating the “fresh go”; and
cooling the “fresh go”.

24. A highly concentrated soybean milk paste with a concentration of 22±4 BRIX produced by a process comprising:
providing a “fresh go” by mixing and stirring any one of soybean powder, milled soybeans, and soybean flakes into cold or warm water;
putting the “fresh go” into a retort pouch; and
boiling and heating the “fresh go”; and
cooling the “fresh go”.

25. A highly concentrated soybean milk paste with a concentration of 22±4 BRIX produced by a process comprising:
providing a “fresh go” by mixing and stirring any one of soybean powder, milled soybeans, and soybean flakes into cold or warm water; and
pressure-heating the “fresh go” in a retort pouch for pasteurization.

26. A highly concentrated soybean milk paste with a concentration of 22±4 BRIX produced by a process comprising:
providing a “fresh go” by mixing and stirring any one of soybean powder, milled soybeans and soybean flakes into cold or warm water;
putting the “fresh go” into a heat-resistant bag;
boiling and heating the “fresh go”; and
cooling the “fresh go”.
